(19) United States
(12) Patent Application Publication
(10) Pub. No.: US 2017/0008178 A1
(43) Pub. Date: Jan. 12, 2017

(54) DUAL CUTTING BLADE ASSEMBLY

(71) Applicants: Ralph Cristofaro, Las Cruces, NM (US); Janet Cristofaro, Las Cruces, NM (US)

(72) Inventors: Ralph Cristofaro, Las Cruces, NM (US); Janet Cristofaro, Las Cruces, NM (US)

(21) Appl. No.: 14/792,820

(22) Filed: Jul. 7, 2015

(51) Int. Cl. B26B 5/00

(52) U.S. Cl. CPC B26B 5/008

(57) ABSTRACT

A dual cutting blade assembly that includes: a cylindrical handle; a receiving bracket at a first end of the cylindrical handle; a blade holder, where the blade holder mounts into the receiving bracket; two cutting blades extending from the blade holder, where the cutting blades are parallel to the cylindrical axis of the handle. Preferably, the two cutting blade are removably mounted within a cavity of the blade holder. In one exemplary embodiment, the two cutting blades may be equal in length or alternatively the two cutting blades may be unequal in length. The blade holder includes a mounting post, where the mounting post inserts into the receiving bracket. Preferably, the two cutting blades are separated at a fixed distance within the cavity or alternatively the distance between the two cutting blades varies.

### BACKGROUND OF THE INVENTION

Field of Invention

The present invention relates to a dual cutting blade assembly used to cut various types of materials.

Description of Related Art

Seamstress and upholsters use a variety of tools to cut and design cloth materials. Many times these materials must be cut to precision in order to provide a proper design cut and a fit for the item being created. Further certain instances cloths must be cut at a consistent width to avoid errors in the overall production. For certain types of cuts it would be advantageous to have parallel dual cutting blades that are able to create strips of material without repeated cutting and to provide uniform width while cutting. Use of such a type of cutting device could be helpful both in clothing design and upholstery design.

### SUMMARY OF THE INVENTION

The present invention relates to a dual cutting blade assembly that includes: a cylindrical handle; a receiving bracket at a first end of the cylindrical handle; a blade holder, where the blade holder mounts into the receiving bracket; two cutting blades extending from the blade holder, where the cutting blades are parallel to the cylindrical axis of the handle. Preferably, the two cutting blade are removably mounted within a cavity of the blade holder. In one exemplary embodiment, the two cutting blades may be equal in length or alternatively the two cutting blades may be unequal in length. The blade holder includes a mounting post, where the mounting post inserts into the receiving bracket. Preferably, the two cutting blades are separated at a fixed distance within the cavity or alternatively the distance between the two cutting blades varies.

### BRIEF DESCRIPTION OF DRAWINGS

FIG. 1 depicts a plurality of spacers used in conjunction with the present invention.

FIG. 2 depicts a dual cutting blade assembly in accordance with the present invention.

FIG. 3A depicts a side view of a blade holder used in conjunction with the present invention.

FIG. 3B depicts a top view of the blade holder in accordance with the present invention.

FIG. 3C depicts a front view of the blade holder in accordance with the present invention.

FIG. 4 depicts a safety protector used to cover the cutting blade of the present invention.

### DETAILED DESCRIPTION

The present invention relates to a dual cutting blade assembly that provides parallel dual cutting blades in a handheld utility device. The dual cutting blade assembly according to the present invention includes a cylindrical handle with a receiving bracket at the first end of the cylindrical handle. The receiving bracket receives and secures in place a blade holder. The blade holder in turn receives two cutting blades extending from the blade holder, which are run parallel with the cylindrical axis of the handle. Blades enable a user to cut a strip of fabric or material in one cut to maintain a consistent width with the use of the dual blade cutting device. A cavity within the blade holder receives the cutting blades and provides a means for the blades within the blade holder. Various types of blades may be used with the blade holder in accordance with the present invention and mounted within the cavity. In addition to the blades, spacers may be inserted into the cavity to provide spacing between the dual blades. A further feature of the present invention is a safety protector that is placed over the blades when not in use.

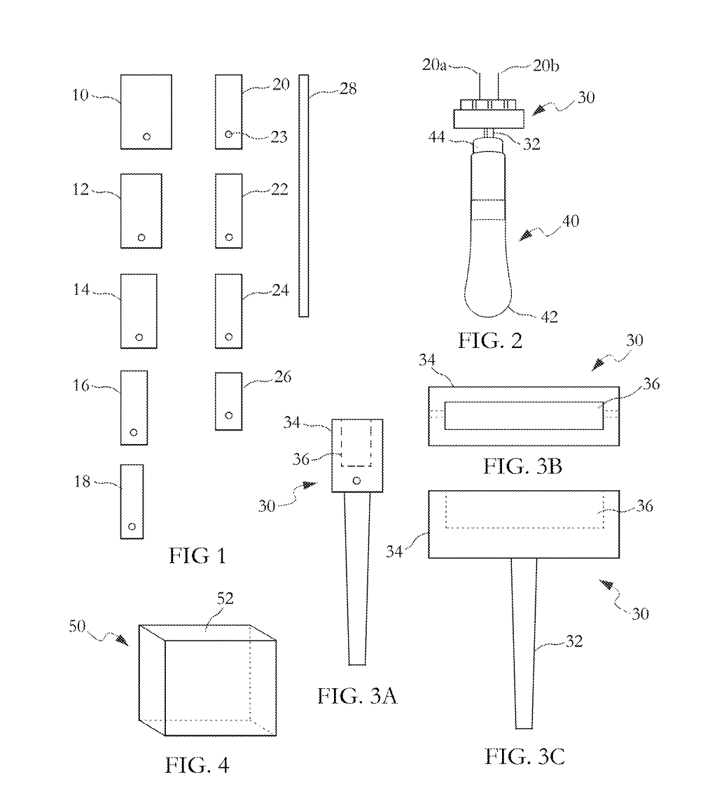

In reference to FIG. 1, a plurality of spacers 10, 12, 14, 16, 18, 20, 22, 24 and 26 are shown that are used in conjunction with the present invention. It is noted the spacers 10, 12, 14, 16, 18, 20, 22, 24 and 26 may vary in width and Spacers 20, 22, 24 and 26 are shown that may be used with the spacers 10, 12, 14, 16, 18. Each spacer includes a Pinhole 23 as shown. Further shown in FIG. 1 is an exemplary side view of a spacer 28.

FIG. 2 depicts a complete dual cutting blade Assembly 40 in accordance with the present invention. The dual cutting blade Assembly 40 includes a Handle 42 that is substantially cylindrical in shape. The cylindrical shape handle 42 includes a receiving Bracket 44 at one end of the handle. The receiving bracket receives a Blade Holder 30. The blade holder 30 includes a Mounting Post 32. This Mounting Post 32 inserts into the Bracket 44 to secure the dual Blades 20a, 20b shown in FIG. 2. The Blades 20a, 20b are parallel with each other and create a defined width between the blades thus creating a consistent width for cutting purposes.

FIG. 3A shows a side view of the Blade Holder 30. Blade Holder 30 as stated includes a Mounting Post 32 and a Blade Receiver 34 with a Cavity 36. The Blade Receiver 34 is at the top of the Mounting Post 32. FIG. 3B depicts a top view of the Cavity 36 of the blade Receiver 34. The Blade Receiver 34 is also shown at FIG. 3C with a front view showing the Cavity 36 within Mounting Post 32.

The dual blade assembly provides a convenient tool for use by a seamstress or upholsterer for cutting various types of materials at a consistent width. FIG. 4 depicts a safety protector 50 in the form of a square enclosure. The Safety Protector 50 includes an Opening 52, where preferably the Safety Protector 50 in made of Styrofoam. The blades protrude into the Styrofoam of the Protector 50, which secures the blades when the dual cutting blade Assembly 40 is not in use. The blade assembly therefore provides an excellent tool for any user. The instant invention has been shown and described in what it considers to be the most practical and preferred embodiments. It is recognized, however, that departures may be made there from within the scope of the invention and that obvious modifications will occur to a person skilled in the art.

What is claimed is:

1. A dual cutting blade assembly comprising:
a. a cylindrical handle;
b. a receiving bracket at a first end of the cylindrical handle;
c. a blade holder, where the blade holder mounts into the receiving bracket;
d. two cutting blades extending from the blade holder, where the cutting blades are parallel to the cylindrical axis of the handle.

2. The dual cutting blade assembly according to claim 1, where the two cutting blade are removably mounted within a cavity of the blade holder.

3. The dual cutting blade assembly according to claim 1, where the two cutting blades are equal in length.

4. The dual cutting blade assembly according to claim 1, where the two cutting blades are not equal in length.

5. The dual cutting blade assembly according to claim 1, where blade holder includes a mounting post and said mounting post inserts into the receiving bracket.

6. The dual cutting blade assembly according to claim 2, where two cutting blades are separated at a fixed distance within the cavity.

7. The dual cutting blade assembly according to claim 2, where a distance between the two cutting blades varies.

8. The dual cutting blade assembly according to claim 2, where the cavity is set a predetermined depth to accommodate the two cutting blades.

9. The dual cutting blade assembly according to claim 1, where a plurality of cutting blade sizes may be mounted within the blade holder.

10. The dual cutting blade assembly according to claim 1, where the blade holder has a width greater than the cylindrical diameter of the handle.
